(19) United States
(12) Patent Application Publication
(10) Pub. No.: US 2016/0012395 A1
(43) Pub. Date: Jan. 14, 2016

(54) Human Capital Rating, Ranking and Assessment System and Method

(71) Applicant: Morphlynx, Inc., Ashburn, VA (US)

(72) Inventor: Samer Mohammed Omar, Ashburn, VA (US)

(21) Appl. No.: 14/325,821

(22) Filed: Jul. 8, 2014

(51) Int. Cl. G06Q 10/10

(52) U.S. Cl. CPC G06Q 10/105

(57) ABSTRACT

The present invention provides a method and system for managing career data using a computing environment. The method and system includes receiving user career-related data from an input source and generating a rating of the user career-related data, wherein the rating is dynamically updated over time as contributing factors change. The method and system further includes generating a gap analysis of the user career data from the general career data, wherein the gap analysis includes at least one determination of delta factors between the user career data and the general career data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to data management systems and more specifically to the collection, tracking, processing and management of career data in a computing environment for a variety of users.

### BACKGROUND

Human capital development and talent management is a core challenge for businesses. These development and management functions are difficult, expensive and typically inefficient using traditional methods of consultancy and enterprise software. Additionally, individual professionals are challenged by the lack of consistent metrics and reliable evaluations of their professional stature, including the lack of effective progress setting and tracking tools.

By way of example, professionals in the Information Communications and Technology (ICT) discipline are challenged by the pace of technology and skill developments. For employers in any space, including the ICT space as an example, it is imperative to track employee skills and proficiencies, so as to not only manage the existing workforce, but also to note employee needs for training and project assignments. Most human resource departments cannot keep up with the fast-paced changing environment, and such a failure to actively monitor their employees' career development and qualifications can lead to institutional concerns including optimized use of employees, effects on employee morale, employee retention, and overall lost productivity.

Currently, there exist many disparate systems and software programs that provide basic level of employee and career tracking data. These systems operate in a traditional silo environment, either producing results for system-specific functionality or being loosely integrated with limited functionality therebetween.

For example, employee management software can track employee statistic and human resource related information for various employees. These systems will track generalized information as received by the system, including for example employee name, background, pay, length of service, etc. These systems are primarily data tracking and reporting systems, electronically saving submitted information with the ability to generate reporting features.

This career data continues to exist in the various silos, failing to account for cross-platform benefits. Another relatively recent phenomenon is the development of business and social media web-based platforms. These computing platforms provide a central networking repository where users enter their professional information and create networking connections with co-workers, contacts and associations. Users update this information as their careers and accomplishments progress and users generate their professional network.

Again, this linking up between different users operates in a silo, where the data is essentially exclusively contained within that social media platform. Similarly, the other career and professional development platforms fail to inter-operate. This leaves major knowledge gaps for personal-use, businesses, educational institutions and others. This also creates many negative repercussions on the efficiency of the current workforce, the career advancement and upward mobility of professionals. It limits the usefulness of the various computing silos by failing to have cross-communication between these systems, platforms and the data they contain.

In addition to the above, the reliability and accuracy of past systems are highly suspect, as professional data can quickly become stale, and corroborations of education, employment and experience can be made by multiple sources of varying reliability, leading to the perception that, for example, two candidates for a new position might be unfairly compared based upon false or highly suspect data from corroborators.

As such, there exists a need for a method and system that tracks and manages career data for use across multiple computing platforms, and further incorporates advanced corroboration and rapid updating mechanisms to ensure that professional stature, rating and ranking information for professionals is highly accurate, up-to-date and with a defined level of corroboration.

### SUMMARY OF ASPECTS OF THE INVENTION

The present invention provides methods and systems for establishing, managing, tracking, updating, corroborating, publishing and evaluating career data using a computing environment. In various embodiments, the present invention can operate in a software-as-a-service (SAAS) platform across a networked environment. The present invention can be employed by corporate users, such as human resources (HR) professionals, company administrators, etc., as well as by career information and professional advancement entities, individual professionals and others. Exemplary methods and systems include receiving user career data from a computing input source and electronically generating a rating and a ranking of the user career data against general career data. Exemplary methods and systems further include electronically generating a gap analysis of the user career data from the general career data, wherein the gap analysis includes at least one determination of delta factors between the user career data and the general career data. Exemplary methods and systems further include providing, as an electronic output, at least one suggested career activity for the user based on the gap analysis, such that the performance of the at least one suggested career activity improves the ranking of the user career data against the general career data.

In one embodiment of the present invention, baseline categorizations for career types can be established, such as a combination of various components including but not limited to, education history, professional experience, professional skills (which can include soft, technical and/or business skills, for example), professional training, professional certifications and professional network (e.g., business contacts), for example.

In various embodiments, baseline categorizations can begin by defining a job or career title, and then decomposing it into categories such as education requirements, experience requirements, professional skills requirements, professional training requirements and professional certification requirements, for example. It will be appreciated that a baseline in one career area may comprise all of the above categories, while a baseline in another career area may comprise less than all of the above categories.

Within the categories of a particular baseline, the present invention permits the ranking of various elements. For example, using the system of the present invention, a user (e.g., a corporate user establishing scoring rules for evaluating ratings and rankings of professionals) can define the rank and score for (1) a range of universities, (2) a range of employers, including purely local as well as global employers, and (3) levels of education (e.g., two-year college, four-year college, masters degrees, doctorate degrees, etc.). Various embodiments of the present invention can then evaluate factors associated with a given baseline and a given user's career data to generate a score. Further, the present invention allows for extra scoring based on level of confidence in the information being provided. In various embodiments, the level of confidence can come through multiple checks, including, for example, validation and endorsement. Validation can be based on multiple levels. As will be appreciated, the more stringent and accurate the source, the higher the score for that element. For example, someone providing validation directly from their university confirming their degree and years graduated can be provided with the full amount of available points versus someone simply defining their university in their profile with no supporting evidence. With regard to endorsement, an endorsement from individuals in a user's professional network can help boost their score. In various embodiments, endorsements can only be made by someone already in a user's network. Also, in various embodiments, a corroborator's endorsement can be weighted by their own Power Rating and/or Power Ranking. For example, someone with a score of 90 endorsing another user will carry a 90-point endorsement, versus someone with a score of 70 who will only carry 70 points in their endorsement. Further, an endorsement must be valid, meaning that someone endorsing the education part of a user's profile should have attended the same university during the same period; otherwise, the endorsement can be rejected or its impact marginalized. Similarly, a corroborator endorsing a user's professional experience is considered valid if the corroborator worked at the same company at the same time as the user, while an outsider simply claiming that they believed the user to have worked at the company may not be given any weight, or only minimal weight, for example. Further, an endorsement for someone's skills can be considered to be only valid if the corroborator already has that skill, since another person within the industry is likely to be much better suited to confirming that a user has the skill they are proclaiming. In various embodiments, the Power Ranking of the endorser can be used to bolster the score of the endorsee, as noted above.

It will be appreciated that embodiments of the present invention provide a distinction between a Power Rating and a Power Ranking. In various embodiments, a Power Rating can be determined as the weighted and calculated score of a professional's relevancy to a particular job and all the associated vetting (e.g., validation, corroboration and/or endorsements) including their professional social network. In various embodiments, a Power Ranking can be the rank of that person as it relates to their current job role within their local, regional and global geographic markets. A Power Rating can be the combination of multiple factors (e.g., Education, Experience, Skills, Certifications, Professional Network (including the Power Rankings of individuals in it), Credit Scores, Desired Characteristics (e.g., verification of no criminal background)) plus other factors as desired, such as those related to specific industries including other specific indices. In various embodiments, the Power Rating continues to evolve and change over time to include all relevant information that would define the human capital value of a professional. The Power Ranking can then be used to define the professionals rank locally, regionally and globally to determine how competitive they are with others in the same industries. For instance, a computer science engineer can have a Power Rating of 389, and that rating may give them a Power Ranking of 95% in their city, 92% in their state, 85% in their country and 81% internationally.

With specific baseline categories, embodiments of the present invention permit an administrative user to establish scores and influence factors in each category. For example, in the Education category, a scoring system can be provided that differentiates scores based upon the education acquired by a user (e.g., high school diploma, two-year college, four-year college, master's degree, doctorate degree, etc.), the perceived quality of the education (e.g., ranked universities, Ivy League universities, etc.), the endorsement of the user's education, and validation of the user's education. In one embodiment of the invention, the validation can be designated as Level Zero (lowest) up to Level Three (highest), where Level Zero is user defined (e.g., a user statement that he/she attended the University of Oregon), Level One contains user inputs supporting data in the form of a user attachment (e.g., a photocopy of a degree from the University of Oregon), Level Two involves a trusted third party providing evidence or confirmation (e.g., a prior employer confirms the user's attendance at the University of Oregon), and Level Three involves a source confirming the information (e.g., the University of Oregon provides a confirmation of the user's degree).

As a further example, in the Professional Experience category, a scoring system can be provided whereby scores are differentiated based on the perceived quality of a user's experience. For instance, quality can be quantified according to a ranking system for employers, such that if global experience is valued, global companies and global places of employment are ranked higher and a user who has worked for the higher rated companies is given a higher score. As a further example, length of employment can be valued such that employees with longer tenures at their employers are given higher scores than those of shorter duration. As with the Education category, endorsements and validation can be measured and scored.

In a similar manner to Education and Professional Experience, scoring systems can be established for other categories such as Skills, Certifications, Professional Network, Financial Credit Scores, Industry Specific Third Party Rankings and other categories. In various embodiments, the present invention is adaptable such that administrative users can add categories and scoring systems to suit their needs. Various graphics can be provided in accordance with aspects of the present invention for visual indications of ratings and rankings. For example, in representing Power Rankings, embodiments of the present invention can show one or more graphs or charts indicating how a given person ranks locally, geographically and globally.

It will be appreciated that scores provided according to embodiments of the present invention are not merely static weighted scores, but are rather ratings provided as derived dynamic values based on multiple inputs. It will further be appreciated that embodiments of the present invention incorporate the rating of others and their impact on the overall rating of an individual via network score but also via endorsement or relevant information in another person's professional profile. For example, given two identically educated and experienced computer science engineers, where a first engineer is endorsed by another user having a high Power Rating, and a second engineer is not endorsed at all, or is endorsed by a user having a relatively lower Power Rating, the first engineer will obtain a higher Power Rating, and thus likely a higher Power Ranking than the second according to embodiments of the present invention.

It will further be appreciated that embodiments of the present invention encompass negative weighting, whereby, for example, pieces of information that are invalidated through one of the validation processes can result in that information being removed from the profile and thereby impacting the related user's rating negatively. In providing for such differentiation, the endorsement and/or vetting process helps to produce an authoritative and accurate accounting of users' professional identities. The vetting processes incorporated by embodiments of the present invention are closely related to the ratings because the higher the vetting reliability, the higher the score. It will be appreciated that the vetting processes in accordance with aspects of the present invention take into consideration verification and validation of the user's input. Note that sources of validation can provide confirming information through a semi-automated electronic method or a fully automated validation with the appropriate agreement of release of information from the professional allowing the source to share data with the core system, according to aspects of the present invention. In various aspects, the vetting process also leverages the use of professional social networking through the use of endorsements from people in our network. In various embodiments, the system will not allow users to endorse someone on a subject matter that the user himself or herself does not have a proven competency in, as noted above. For example, if a potential endorser did not attend Harvard during the same period as a potential endorsee who claims to have attended Harvard during a given period of time, the potential endorser cannot endorse the potential endorsee.

In aspects of the present invention, a user's rating and ranking can be constantly changing with the changes in baseline definitions which evolve per each job as a given industry changes. Ratings and rankings can also evolve according to changes in user input and endorser input, for example.

In aspects of the present invention, a user can learn about what specific education, skills or experience can influence his or her Power Rating and/or Power Ranking. For example, a user may learn that a two-year internship with a global manufacturer at a South American office can be deemed a relatively rare but desirable experience. Further, users can learn what education, skills or experience can make them more well-rounded, or well “sharpened” to meet desired background requirements for future employment, for example.

In addition to the above, system operators can elect to organize a rating and ranking according to specific desires and needs.

### BRIEF DESCRIPTION OF THE DRAWINGS

Embodiments of the invention are illustrated in the figures of the accompanying drawings which are meant to be exemplary and not limiting, in which like references are intended to refer to like or corresponding parts, and in which:

FIG. 1 illustrates a system diagram of one embodiment of a computing system for tracking career data;

FIG. 2 illustrates a block diagram of a computing system providing a method for career data tracking;

FIG. 3 illustrates a graphical representation of one embodiment of a career data database and its multiple data sources;

FIG. 4 illustrates a flowchart of the steps of one embodiment of a method for career data tracking;

FIG. 5 illustrates a block diagram of one embodiment of a computing process flow; and

FIGS. 6-13 illustrate sample screen shot of career dashboard displays.

### DETAILED DESCRIPTION OF EMBODIMENTS

In the following description, reference is made to the accompanying drawings that form a part hereof, and in which is shown by way of illustration specific embodiments in which the invention may be implemented. It is to be understood that other embodiments may be utilized and design changes may be made without departing from the scope of the present invention.

It is well understood and appreciated that a user's career background communicates meaningful information about a user's future abilities. The user's credentials and other career data provide a trove of information about the user, especially in environments where computerized screen techniques are further improving the filtering process for job applicants and job seeking operations, as well as employee and business knowledge management within a company. The user's career placement can be characterized as a ranking value relative to any number of benchmarks, and this ranking is then usable for any number of benefits as described below. For example, one benefit is in an employee hiring process, whereby job applicants can determine jobs for which they are best qualified and then seek application. Another example is career management, such as tracking a user's career to determine where the user needs to improve his or her background/experience to keep pace with his or her co-workers and/or industry colleagues, or otherwise progress to higher employment levels.

FIG. 1 illustrates a computing system 100 including a user 102, user computing device 104, network connection (exemplified as Internet) 106 and processing device 108. The system 100 additionally includes a rating and ranking engine 110, a gap analysis and activity engine 112 and at least two data storage devices including a user data storage device 114 and career data storage device 116.

The user 102 can be any relevant user including an employee, a human resource (HR) manager, an individual in his or her personal capacity, a supervisor or other non-HR person. The computing device 104 can be any device capable of receiving and transmitting input, including but not limited to a laptop or mobile computing device, a desktop computer, and/or a smart phone or tablet computer. The network 106 can be any network including but not limited to an intranet or the Internet, as well as any suitable private or public network connection allowing for communication between the computing device 104 and the processing device 108.

The processing device 108 can be any suitable computing device operative to perform processing operations, as described in further detail below. The processing device 108 can be one or more processing devices in a central or distributed computing environment, including operating on a single computing platform or computing and sharing resources across any number of platforms. The processing device 108 is illustrated in FIG. 1 as a single component for convenience purposes only and it is recognized that this device 108 can be multiple processors connected across any suitable networked environment as recognized by one skilled in the art.

The data storage devices 114 and 116 can be any suitable type of data storage device and may be individual devices or representative of multiple storage locations across one or more networks. By way of example, the database 114 can include data storage across multiple servers or computing systems networked together in a distributed environment. Wherein, the data 114 stores user data, as described in further detail below, and the career data database 116 stores career data, additionally as described in detail below. Generally, career data stored in the career data database includes data relating to skills, experience, education, publications, professional affiliations, networks, endorsements and any other data relating to a persons career and/or professional development.

In various embodiments, the rating and ranking engine 110 includes one or more processing device operative to perform rating and ranking operations. In one embodiment, the engine 110 can be software or other executable code executed in one or more processing devices for the performance of rating and ranking operations. Similarly, the gap analysis and activity engine 112 can be software or other executable code executed in one or more processing devices for the performance of operations described herein below.

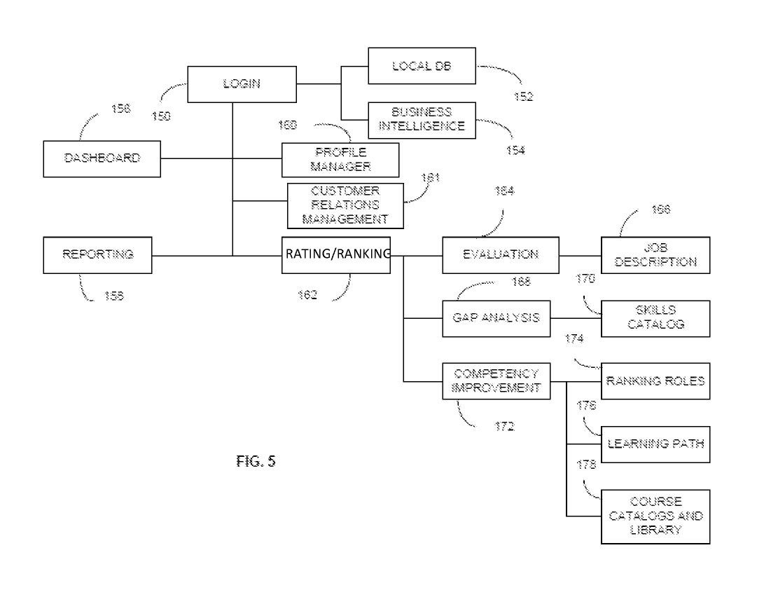

It is recognized by one skilled in the art that various processing and communication components of FIG. 1 have been omitted for brevity purposes only. Various embodiments of the operations of the system 100 are described in further detail below, including but not limited to the flowchart of FIG. 4.

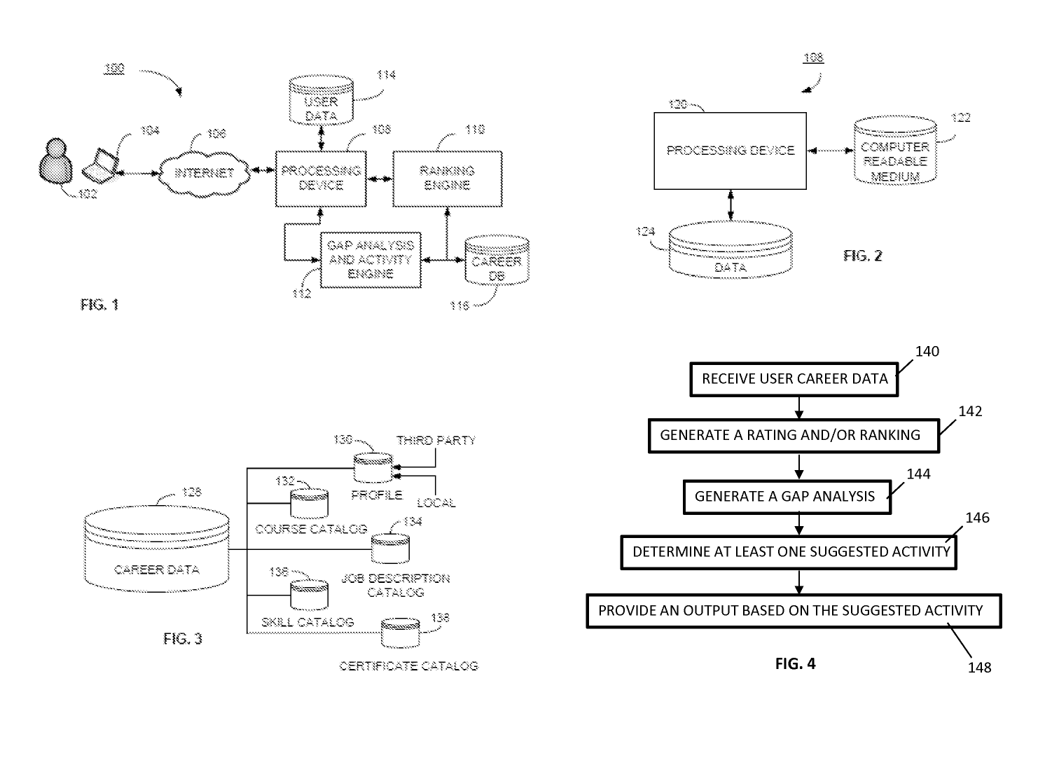

For further reference, FIG. 2 illustrates one embodiment of the processing device 108 including one or more processing devices 120, computer readable medium 122 and data storage device 124. The computer readable medium having executable instructions stored therein and the data storage device 124 including data available by the processing device for performing processing operations thereupon.

As the embodiments described below, various embodiments include the operations performed by the processing device 120 in response to the executable instructions from the computer readable medium 122, in accordance with known processing techniques recognized by those skilled in the art. The processing operations of the processing device 120 can be upon the data stored in the database, wherein the database may be any suitable storage device including for example databases 114 and/or 116.

FIG. 3 illustrates a block diagram of one embodiment of the data compilation of the career data database 128, which can be similar to or identical to the database 116 of FIG. 1. The career data database 128 includes data from any number of variety of sources and the collective storage of that data therein. The data can pertain to career success factors, for example, either taken from external sources or created and stored by a user of embodiments of the present invention.

For example, the database 128 includes profile data from a profile data database 130. The profile data can be from any number of sources including third party sources, such as for example external networked locations like a professional networking website. The profile data can be local to the computing system, such as data from registered account users. The profile data generally contains profile data relating to the user and the user's credentials. Typical data can include the user's educational background, the user's certification, the user's training credentials, the user's work experience, the user's demographic/personal information, the user's career objectives, as well as any other suitable data.

The career data database 128 additionally receives data from a course catalog database 132. This database 132 includes information relating to available educational/training courses. This data can be categorized by user skill level pre-requisites, course topic, course content and any other information relating to the providing of training or other types of knowledge and/or skill improvement activities for attendees.

The career data database 128 additionally receives data from a job description catalog database 134. The catalog data in the database 134 relates to job descriptions. It is understood that the present processing system includes standardized job descriptions, therefore disparate job listings can be equally compared against each other. Therefore, the job description catalog includes any number of job descriptions, including qualification requirements, e.g. education, skill, certification, etc.

The career data database 128 additionally receives data from a skill catalog database 136. The skill catalog data includes data for professional skill levels describing and defining skills required for various professions, including but not expressly limited to, job descriptions, background data, job requirement data, job certification data, pay or income data, demographic information, among others.

The career data database 128 additionally receives data from a certificate catalog database 138. This data includes information relating to certification levels. In some professions, including in the ICT profession, for example, certification is required for various levels of career advancement. Therefore, this data includes a catalog of certifications, including for example skill requirements and educational requirements for reaching various certification levels. Based on the certification data, it is understood if a user is certified, can be certified, should be certified and how certification can affect and/or improve a person's professional development.

Therefore, the career data database 128 includes a large collection of career data usable for the herein described operations. This data may include pre-processing for removing extraneous data points, as well as reformatting or otherwise modifying the data for consistent usable data from multiple sources in a single processing platform.

FIG. 4 illustrates a flowchart of the steps of one embodiment of a method tracking career data. The steps of the flowchart of FIG. 4 may be performed by the system 100 of FIG. 1, including processing operations performed by the processing device 120 of FIG. 2 in response to executable instructions.

In the methodology of FIG. 4, a first step, step 140, is receiving user career data, such as from a computing input source, for example. This step may include any number of various embodiments, including the user 102 of FIG. 1 entering personal information including resume or personnel data, a manager or supervisor entering employee data, an HR professional entering HR employee data, a recruiting coordinator entering career data for candidates or clients, protected social community information for a specific user (e.g., LinkedIn®, Xing®, Facebook®), a corroborator, who may be a co-worker, fellow alumni, former colleague or other user with some affiliation to a professional identified in accordance with aspects of the present invention. With reference to FIG. 3, this data may include the profile data from database 130.

The receipt of the user career data may be via a web and/or WAP interface or other type of computing interface. For example, in a software-as-a-service (i.e., cloud-based) platform, the data entry may be via a web-based data entry portal running a local data entry page via a browser or other type of local resident software. As noted in FIG. 1, various embodiments include receiving the user career data via the Internet 106 or third party data in various computing technologies, and is not limited for API internet-based and/or data exchange tools.

In the exemplary methodology of FIG. 3, a next step, step 142, is generating a rating and/or ranking of the user career data, wherein the rating and/or ranking can be provided against general career data. With reference to FIG. 1, the data is received via the processing device 108 and passed to the rating and ranking engine 110. The user data may be stored in the user data database 114 prior to rating and/or ranking.

In one embodiment of the present invention, baseline categorizations for career types can be established, such as a combination of various components including but not limited to, education history, professional experience, professional skills (which can include soft, technical and/or business skills, for example), professional training, professional certifications and professional network (e.g., business contacts), for example.

In various embodiments, baseline categorizations can begin by defining a job or career title, and then decomposing it into categories such as education requirements, experience requirements, professional skills requirements, professional training requirements and professional certification requirements, for example. It will be appreciated that a baseline in one career area may comprise all of the above categories, while a baseline in another career area may comprise less than all of the above categories. It will further be appreciated that baseline categorizations can be consistently reviewed and updated to make sure they comport with industry norms, including surveys and inputs from professional associations, for example. Such review and updating can occur via inputs such as computing devices 104, for example.

Within the categories of a particular baseline, the present invention permits the ranking of various elements. For example, using the system of the present invention, a user (e.g., a corporate user establishing scoring rules for evaluating ratings and rankings of professionals) can define the rank and score for (1) a range of universities, (2) a range of employers, including purely local as well as global employers, and (3) levels of education (e.g., two-year college, four-year college, masters degrees, doctorate degrees, etc.). Various embodiments of the present invention can then evaluate factors associated with a given baseline and a given user's career data to generate a score. Further, the present invention allows for extra scoring based on level of confidence in the information being provided. In various embodiments, the level of confidence can come through multiple checks, including, for example, validation and endorsement. Validation can be based on multiple levels. As will be appreciated, the more stringent and accurate the source, the higher the score for that element. For example, someone providing validation directly from their university confirming their degree and years graduated can be provided with the full amount of available points versus someone simply defining their university in their profile with no supporting evidence. With regard to endorsement, an endorsement from individuals in a user's professional network can help boost their score. In various embodiments, endorsements can only be made by someone already in a user's network. Also, in various embodiments, a corroborator's endorsement can be weighted by their own Power Ranking. For example, someone with a score of 90 endorsing another user will carry a 90-point endorsement, versus someone with a score of 70 who will only carry 70 points in their endorsement. Further, an endorsement must be valid, meaning that someone endorsing the education part of a user's profile should have attended the same university during the same period; otherwise, the endorsement can be rejected or its impact marginalized. Similarly, a corroborator endorsing a user's professional experience is considered valid if the corroborator worked at the same company at the same time as the user, while an outsider simply claiming that they believed the user to have worked at the company may not be given any weight, or only minimal weight, for example. Further, an endorsement for someone's skills can be considered to be only valid if the corroborator already has that skill, since another person within the industry is likely to be much better suited to confirming that a user has the skill they are proclaiming. In various embodiments, the Power Ranking of the endorser can be used to bolster the score of the endorsee, as noted above.

As noted above, the rating and ranking engine 110 operates to rate and/or rank the career data across numerous and multiple career data platforms. The engine receives rating and/or ranking factors and rates and/or ranks the data based on these factors.

In various embodiments, rating factors may be generated based on computational analysis of the career data stored in career data database 116. In one example, rating of career data may include rating experience levels for employees. Using the example of the ICT professionals, it may be important to know not only computer and software qualifications, but also years of experience. So while different individuals may have complementary experience backgrounds, those backgrounds may be defined by different terms or characterizations. For example, if a user is certified but has little actual experience, that qualification level must be comparable relative to someone who has no certification but a lot of actual experience. Therefore, the rating and ranking engine 110 provides for quantifying the career data received from the user via the input source.

In one embodiment, the rating step 142 includes a first step to quantify the career data, or more specifically, elements of the career data, into value components. By way of example, the career data may be divided up into numerous categories, including education levels, certification levels, years of experience, etc. as noted herein. The data for each of these categories then reflects career data points, which is usable for career tracking.

Therefore, based on the generalization of the various forms of career data into a generally usable format, the career data itself is usable, regardless of the system used to enter the data, therefore the performance of career tracking can be done across numerous HR and business intelligence platforms. Prior techniques operating in silo-based systems fail to allow for the comparison of data from different systems, where career data in an HR system is not comparable to career data listed on a professional networking site. But by categorizing and rating/ranking the data, these systems become interoperable.

In one embodiment, the rating and ranking engine 110 operates one or more algorithms that include the weighting of multiple key performance indicators (KPIs). For example, the indicators may include education, professional network, experience level, skills, certifications and event and publications. For clarity, the professional network may include a determination of the individuals/professionals to whom the user is networked, such as via a social or professional networking website. The algorithm provides a defined weighting factor for each of these indicators, where the weighting factors may be different for each indicator. It will be appreciated that an administrator or system operator can pre-define categories and weighting factors to be used by the one or more algorithms. The indicator can be expressed in a numerical format, such as a binary representation, for example. This indicator is then multiplied or weighted based on the weighting factor to generate a weighted indicator.

The weighted indicators are then combined to generate a collective value that represents the combination of all weighted indicators. For example, one embodiment may include a 64-bit representation. The education indicator is represented as a 14-bit value and then weighted. The networking indicator is represented as a 15-bit value and then weight. The experience is a series of 10-bits and then weighted. The skills element is a series of 15 bits and then weighted. The certification is a series of 10 bits then weighted and the publication may be a zero-bit. It is recognized that the 64-bit embodiment is not a limiting embodiment and that another suitable number of bits may be utilized. Further, it will be appreciated that weighting of factors is not required.

The various indicators may be further compartmentalized based on make-up components. For example, education may be further subdivided with four bits representing a ranking of the user's university, five bits representing years of education and five bits representing any educational endorsement factors. For further illustration, if the user's school is in the top ten, the binary value may be “0001”; in the top one hundred, the binary value is “0010”; in the top 1000 the binary value is “0100”; and for all the rest “0000”. For years of education, high school may be “0001”; two years of advanced education may be “00010”; four years of advanced education (such as a through a bachelors of science (BS) or bachelors of arts (BA) degree) “00100”; graduate degrees (e.g., MA/MS/MBA) may be “01000”; doctorate degrees (e.g., JD or PHD) may be “10000” and all the rest at “00000”. Endorsements may be a binary representation of “yes” as “1000” and “no” as “0000”.

Similar delineations exist for other components of the indicators. Sub-categories of the indicators are assigned binary values and the collective, in this embodiment, 64-bit value represents the collective value of the user's professional experience. For example, additional sub-indicators can be global ranking of the company and years of experience for the experience indicator; relevant job description and endorsement skill for skills, number of certificates and endorsements for the certificate indicator.

For further reference, an example of generating a rating is described herein. In this example, a user provides career data input and it is determined that the user's university ranking is in the top fifty-nine, the user has a Bachelor of Arts degree and no endorsed education. The user does not have a professional network. The user's experience is with a company having a global ranking in the top 2000, less than a year of experience and has not been professionally endorsed. The user's skills can be compared to a standard dictionary of job skills and it is determined that the user has five skills and no endorsed skills. The user has two professional certificates and no publications or events.

Therefore, based on this information, the rating and/or ranking algorithm(s) is (are) able to generate a 64-bit value representing the user's professional status. The binary values are weighted according to indicator weighting values. The generated 64-bit value is then converted into a decimal value. In one embodiment, the conversion is a simple base-2 to base-10 conversion, e.g., taking the number two to the power of the binary value.

Having this base value, a rating algorithm can now perform the rating. In various embodiments, rating can be based from a baseline value, for example, which in this embodiment is the 64-bit value having all one values. Thus, the baseline value translates to the decimal value of two to the 64^{th} power. Rating is then determined based on division of the baseline value by the user's decimal value. This calculation generates a percentage value, indicating the user's percentage location from an ideal candidate having a perfect score.

In another example, a performance indicator can be endorsements or recommendations by network connections. Different embodiments provide for varying degrees of endorsements, including who can endorse a person and the weighted affect given various endorsements. For example, limitations can be placed so that qualifications are required to accept an endorsement, to help attune the veracity of the endorsements. For example, it may be desirable to prohibit someone endorsing another person's education unless that endorser had actually worked with the user, compared with someone endorsing someone merely because of the user's alma mater. Other various embodiments can be readily employed, whereby the embodiments provide for improving the veracity of endorsements and giving further weight to the value of an endorsement in determining the user's professional rank, wherein endorsements provide a greater level of network feedback usable for a better career analysis for the user.

As noted above, it will be appreciated that embodiments of the present invention provide a distinction between a Power Rating and a Power Ranking. In various embodiments, a Power Rating can be determined as the weighted and calculated score of a professional's relevancy to a particular job and all the associated vetting (e.g., validation, corroboration and/or endorsements) including their professional social network. In various embodiments, a Power Ranking can be the rank of that person as it relates to their current job role within their local, regional and global geographic markets. A Power Rating can be the combination of multiple factors (e.g., Education, Experience, Skills, Certifications, Professional Network (including the Power Rankings of individuals in it), Credit Scores, Desired Characteristics (e.g., verification of no criminal background)) plus other factors as desired, such as those related to specific industries including other specific indices. In various embodiments, the Power Rating continues to evolve and change over time to include all relevant information that would define the human capital value of a professional. The Power Ranking can then be used to define the professionals rank locally, regionally and globally to determine how competitive they are with others in the same industries. For instance, a computer science engineer can have a Power Rating of 389, and that rating may give them a Power Ranking of 95% in their city, 92% in their state, 85% in their country and 81% internationally.

With specific baseline categories, embodiments of the present invention permit an administrative user to establish scores and influence factors in each category. For example, in the Education category, a scoring system can be provided that differentiates scores based upon the education acquired by a user (e.g., high school diploma, two-year college, four-year college, master's degree, doctorate degree, etc.), the perceived quality of the education (e.g., ranked universities, Ivy League universities, etc.), the endorsement of the user's education, and validation of the user's education. In one embodiment of the invention, the validation can be designated as Level Zero (lowest) up to Level Three (highest), where Level Zero is user defined (e.g., a user statement that he/she attended the University of Oregon), Level One contains user inputs supporting data in the form of a user attachment (e.g., a photocopy of a degree from the University of Oregon), Level Two involves a trusted third party providing evidence or confirmation (e.g., a prior employer confirms the user's attendance at the University of Oregon), and Level Three involves a source confirming the information (e.g., the University of Oregon provides a confirmation of the user's degree).

As a further example, in the Professional Experience category, a scoring system can be provided whereby scores are differentiated based on the perceived quality of a user's experience. For instance, quality can be quantified according to a ranking system for employers, such that if global experience is valued, global companies and global places of employment are ranked higher and a user who has worked for the higher rated companies is given a higher score. As a further example, length of employment can be valued such that employees with longer tenures at their employers are given higher scores than those of shorter duration. As with the Education category, endorsements and validation can be measured and scored.

In a similar manner to Education and Professional Experience, scoring systems can be established for other categories such as Skills, Certifications, Professional Network, Financial Credit Scores, Industry Specific Third Party Rankings and other categories. In various embodiments, the present invention is adaptable such that administrative users can add categories and scoring systems to suit their needs. Various graphics can be provided in accordance with aspects of the present invention for visual indications of ratings and rankings. For example, in representing Power Rankings, embodiments of the present invention can show one or more graphs or charts indicating how a given person ranks locally, geographically and globally.

It will be appreciated that scores provided according to embodiments of the present invention are not merely static weighted scores, but are rather ratings provided as derived dynamic values based on multiple inputs. It will further be appreciated that embodiments of the present invention incorporate the rating of others and their impact on the overall rating of an individual via network score but also via endorsement or relevant information in another person's professional profile. For example, given two identically educated and experienced computer science engineers, where a first engineer is endorsed by another user having a high Power Ranking, and a second engineer is not endorsed at all, or is endorsed by a user having a relatively lower Power Ranking, the first engineer will obtain a higher Power Rating, and thus likely a higher Power Ranking than the second according to embodiments of the present invention.

It will further be appreciated that embodiments of the present invention encompass negative weighting, whereby, for example, pieces of information that are invalidated through one of the validation processes can result in that information being removed from the profile and thereby impacting the related user's rating negatively. In providing for such differentiation, the endorsement and/or vetting process helps to produce an authoritative and accurate accounting of users' professional identities. The vetting processes incorporated by embodiments of the present invention are closely related to the ratings because the higher the vetting reliability, the higher the score. It will be appreciated that the vetting processes in accordance with aspects of the present invention take into consideration verification and validation of the user's input. Note that sources of validation can provide confirming information through a semi-automated electronic method or a fully automated validation with the appropriate agreement of release of information from the professional allowing the source to share data with the core system, according to aspects of the present invention. In various aspects, the vetting process also leverages the use of professional social networking through the use of endorsements from people in our network. In various embodiments, the system will not allow users to endorse someone on a subject matter that the user himself or herself does not have a proven competency in, as noted above. For example, if a potential endorser did not attend Harvard during the same period as a potential endorsee who claims to have attended Harvard during a given period of time, the potential endorser cannot endorse the potential endorsee.

In aspects of the present invention, a user's rating and ranking can be constantly changing with the changes in baseline definitions which evolve per each job as a given industry changes. Ratings and rankings can also evolve according to changes in user input and endorser input, for example.

In aspects of the present invention, a user can learn about what specific education, skills or experience can influence his or her Power Rating and/or Power Ranking. For example, a user may learn that a two-year internship with a global manufacturer at a South American office can be deemed a relatively rare but desirable experience. Further, users can learn what education, skills or experience can make them more well-rounded, or well “sharpened” to meet desired background requirements for future employment, for example.

Thus, as described elsewhere herein, aspects of the present invention include establishing a data store of a plurality of career types, with each of the plurality of career types having a baseline categorization of career success factors. Thus, for example, the system can receive data about career success factors such as education, experience, certifications, etc., for career types and job types including pharmaceutical sales, graphic design, executive search, computer programming and unlimited other occupations and careers. During or at a given period of time (e.g., at a specific instant or over a period of time), a user can input and/or the system can receive user career-related data comprising data associated with at least a portion of the career success factors for a given career type. Thus, for example, the system can receive education and experience information for a given user. Further, during or at the given time period, a user can input and/or the system can receive user career veracity data associated with a corroborator, such as a current or former co-worker, fellow alumni, professional network connection or other form of corroborator. The career veracity data can depend upon the type of corroborator involved, as well as the specific corroborating individual. For example, a co-worker may provide career veracity data in the form of a written data input, or an attachment in the form of an electronic file. The system can also determine a corroborator value factor, which can be based on factors such as the validation level of the corroborator and/or the system rating and/or ranking for the corroborator. Further, based on the career veracity data and the corroborator value factor, the present invention can determine a veracity factor. Further, based on the user career data and the veracity factor, the present invention can generate a rating of the user career data associated with the user. At this point, the user has a rating, which can be in a variety of forms, including numerical, that allows the system of the present invention to have a static, point-in-time reference for comparison with other users. The rating can then be stored in a database associated with the present invention. It will further be appreciated that the rating can then be ranked according to various comparisons performed by the present invention, including based upon geographic location, age, age range, gender, political boundary and other elements that can distinguish one user from another.

During or at a later period in time (e.g., at a specific instant or over a period of time), and at or during additional time periods subsequent to the later period, the present invention can update one or more of a variety of factors that affect the user's rating, including the baseline categorization of the specific career involved, the user career-related data and/or the user career veracity data, and thereafter update and store an updated rating for the user. For example, if a certification process becomes available for HR professionals, any user associated with an HR career can be evaluated and rated based on whether he or she has been certified and at what level. Such an additional certification can result in professionals in this category receiving changes in their rating, wherein the changes occur dynamically and are not affected by, and do not require, the user's own input. As another example, the user's career-related data can be updated, such as the user receiving a promotion to a higher position, which can result in a change in the user's rating. As another example, the user can receive additional corroborations as to the user's professional experience by other highly rated users, thereby changing the user's own rating.

In the above-described ways, the present invention can thereby dynamically adapt a user's rating, which affects the user's ranking, in substantially real-time as contributing factors are affected and considered by the system of the present invention.

It is understood that an algorithm in accordance with the present invention and associated indicator categories and values are representative in nature and not expressly limiting embodiments. Therefore, it is appreciated that other indicators may be envisioned and sub-indicators utilized as recognized by one skilled in the art.

Returning to FIG. 3, a next step, step 144, is to generate a gap analysis of the user career data from the general career data, wherein the gap analysis includes at least one determination of delta factors.

In this embodiment, the career data database 116 of FIG. 1 includes the career data assembled and based on a large sampling of career data. This data may be assembled and generated by mining or otherwise collecting various career data submissions across these numerous computing platforms. For example, career data may be acquired from an enterprise system managing HR data, from social and business networking sites, from business intelligence tools, from user profile data, from recruiting and/or job databases, etc.

From the collective normalized career data, baseline data is usable for performing the comparison and generating the delta analysis. In one embodiment, the gap analysis is determined by a direct comparison of the user career normalized data values to the range of career data. Based on the above-described algorithm, there exist readily ascertainable gaps on the user's ranking by determining where low values exists, the low binary values translating into a lower decimal value and hence a lower percentage relative to the baseline value. Therefore, the delta factor determination includes determining indicators wherein the user can readily improve his or her ranking, for example if the user only has a two-year education degree, a delta factor includes the improvement of the user's ranking by seeking a four-year Bachelor's degree.

As shown in FIG. 3, a next step, 146, is determining at least one suggested career activity for the user based on the gap analysis. The gap analysis and activity engine 112, of FIG. 1, may perform this step. This determination is a usable translation of the gap analysis and the delta factors. Using the above example of education, it is thus determinable that a suggested career activity is to increase the user's education level from a two-year degree to a four-year degree. These career activities can run the spectrum of available activities based on the key performance indicators and sub-indicators. For example, career activities can include, but are not limited to, increasing one's professional network, acquiring additional certification, receiving professional endorsements, seeking employment with a more highly regarded employer, speaking engagements, etc.

Therefore, in this embodiment, the final step, step 148, is providing an electronic output to the user based on the career activity. With respect to FIG. 1, this may include the processing device 108 generating an output display to the user 102 via the network 106. In one embodiment, resultant features may be visual displays of the user's career data relative to the general career data set. For example, the user may be provided with a visual display illustrating the percentages and ranges of the user's career statistics relative to the industrial means, medians and/or ranges. In another example, the resultant feature may be a trajectory or career path for the user indicating where the user stands relative to peers and how to advance in his or her career. In this career path example, it may be determinable that if the user becomes certified for a particular software product, the user can then advance in the rankings, so the resultant feature includes not only a display of the user's rankings, but also a recommendation for advancement. As noted above, this display may include any number of possible resultant features, including training and/or certification recommendations, graphical displays, career trajectories display data, resume and/or social networking displays including networking connections and/or recommendations, etc.

In embodiments above, the user career data can include any data usable for career information. This data may include, but is not limited to, education level, job training, performance review, job experience and professional recognition (award) data. In further embodiments, the user data can be part of an on-going tracking system that tracks the user data across multiple years and/or careers paths. This user data may include timely updated information, such updated from annual reviews, quarterly training certification and/or re-certification periods, etc.

FIG. 5 illustrates an operational flow diagram of various embodiments of the career data tracking system. The elements in FIG. 5 represent software modules including executable code executed on one or more processing devices for providing the underlying functionality as noted herein. The data flow includes a user login 150 with access to a local database 152 and a business intelligence system 154. From the login 150, the user has access to four components, a dashboard 156, reporting module 158, a profile manager 160, customer relationship management module 161 and a rating and ranking module 162.

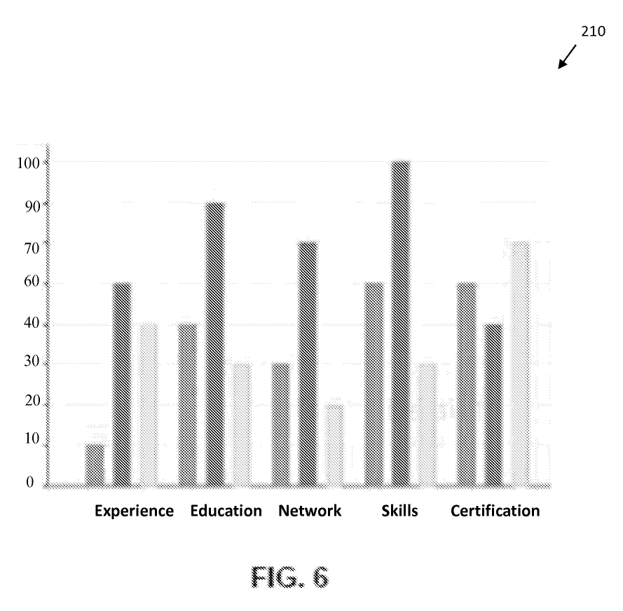

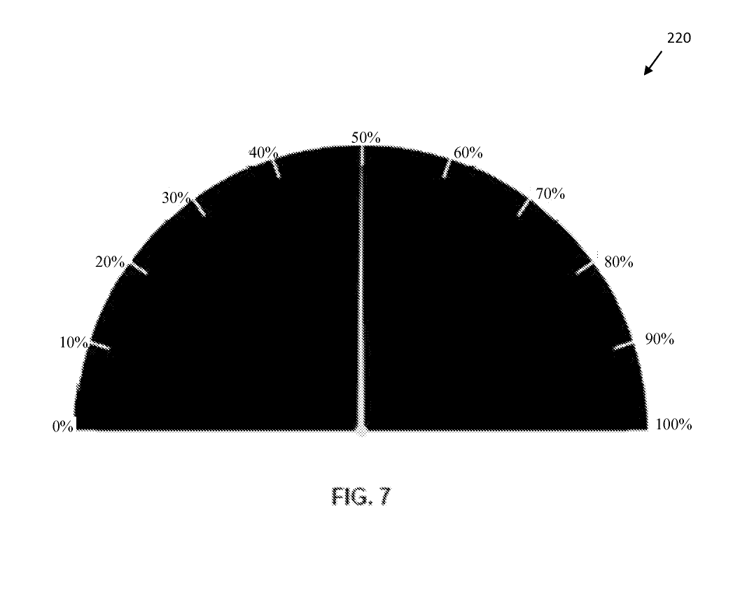

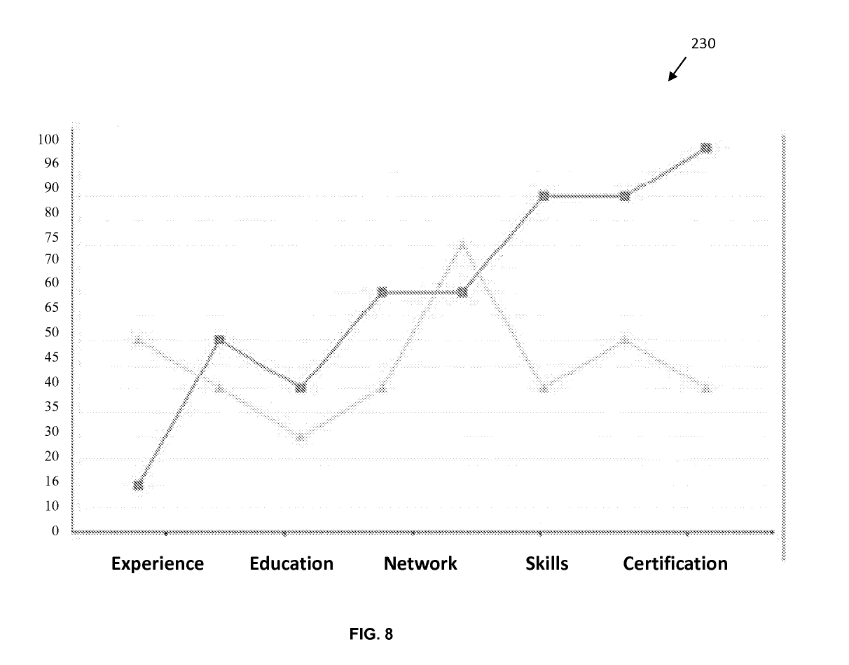

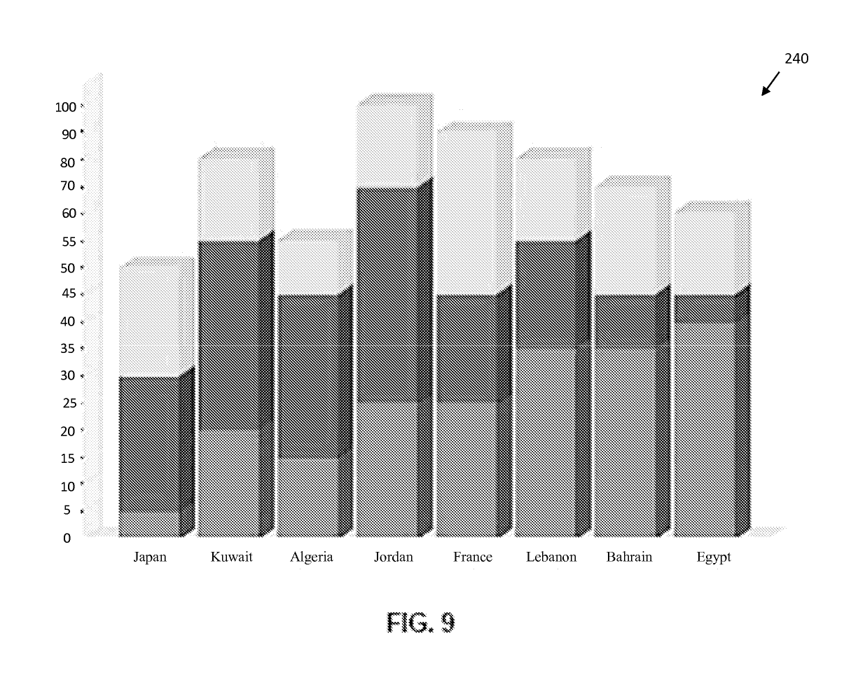

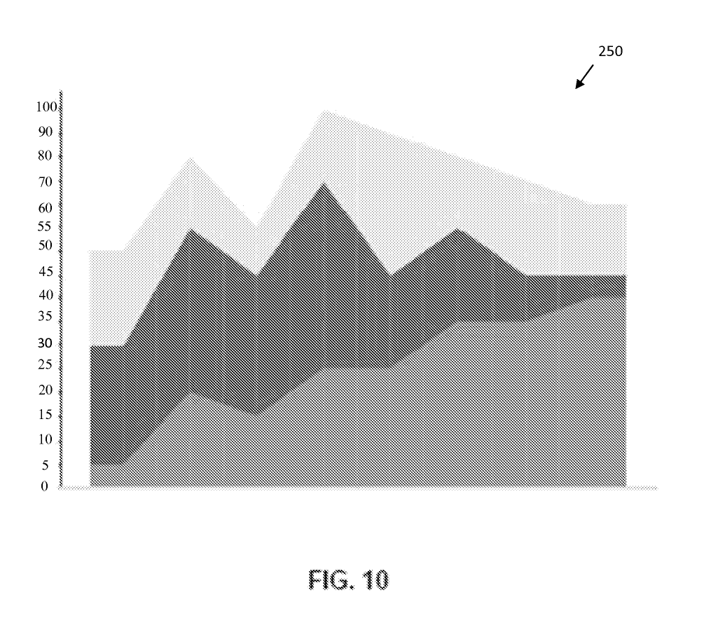

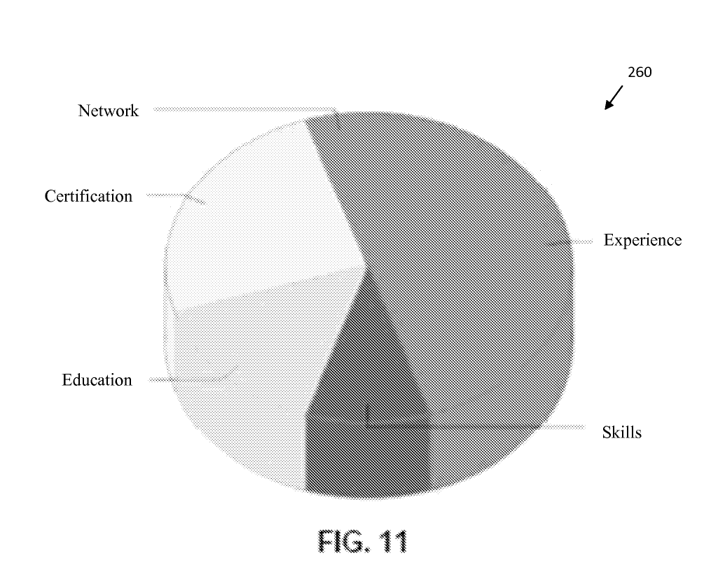

The functionality of a user via the login 150 allows for the tracking of career data and the evaluation of the data for tracking, development and advancement interactivity. For example, the dashboard 156 can provide the visual interface allowing a user to track and interact with the data. For example, FIGS. 6-11 illustrate sample screenshots (210 in FIG. 6, 220 in FIG. 7, 230 in FIG. 8, 240 in FIG. 9, 250 in FIG. 10 and 260 in FIG. 11) of a dashboard display showing the career tracking data. The data may be for the user or for an employee, prospective employee or any other type of individual wherein career data is tracked. Further, FIGS. 12-13 illustrate sample screenshots (270 in FIG. 12 and 280 in FIG. 13) showing company and country comparisons, respectively, of scores, such as may be displayed as one type of output in accordance with embodiments of the present invention. In various embodiments, the present invention can leverage a user's profile to generate a resume and curriculum vitae on demand. The user has the ability to add, remove or modify information extracted from the user's profile including but not limited to Power Rating, Power Ranking, Skills, Experience, Education, and other elements. Further, in various embodiments, the present invention provides for the creation of a career timeline, whereby key milestones can be highlighted, including, for example, career, education, certification, etc. These milestones can be presented in a graphical and color coded timeline with milestones highlighted with relevant graphical icons and associated descriptions.

In the example of a social networking environment, the profile manager may include the input of the user's background, education, certifications, etc. The manager 160 can include the display of public information as well as the retention of private information. In the example of job listings, the profile manager may include listing of openings and/or qualifications for various parties to facilitate the submission of applications. The reporting module 158 can include functionality for mining the career data for the user, as well as the data for the general career data accessible via the normalization techniques described above.

The rating and ranking module 162, which can perform rating and ranking determinations, includes additional modules, including the noted embodiments illustrated herewith. For example, an evaluation module 164 accesses and processes job description data 166 that can include normalized or otherwise generalizing job application data, where different job listing use different terminology. The evaluation engine 164 can include processing for analyzing the terminology of the job description and performing an analysis relative to the user career information, including for example a recommendation for whether the user may be qualified for applying for a particular job.

In another embodiment of the ranking module 162, gap analysis engine 168 processes skills catalog data 170. Based on this information, the engine 168 can determine the differences between a user's current skills and reference information, such as generalized career data as noted above.

Similarly, the ranking module 162 additionally includes a competency improvement engine 172 for improving the user's credentials or professional skills. This engine 172 includes accessing data relating to ranking roles 174, learning path 176 and course catalogs and library 178. The rankings roles include data that indicating career position rankings and the advancement in a career by having a greater career role, how that affects the user's ranking 162. Learning path 176 includes data for how to increase education and knowledge basis for the users, including the ability for educational courses, training courses, certification(s), etc. Similarly, the course catalogs and library 178 provide listings of available resources for improving the user's knowledge base, including with reference to data from the learning path 176. The data 174, 176 and 178 provide resources for the user to improve his or her credentials through improving the user's competency level, therefore the engine 172 is operative to provide recommendations or feedback for the user based on the available resources 174, 176 and 178.

Accordingly, the herein described method and system for managing career data improves over the static prior techniques. Prior techniques for career data have operated in discrete systems lacking the ability to share data. The present method and system improves by, among other things, developing a standard for job descriptions, including roles and responsibilities, developing a standard for skills definitions, standard for career development and/or career paths. Exemplary embodiments of methods and systems provide for standards for ranking professionals based on factors including education, background, endorsement from connections/relationships, professional experience, professional certifications, publications, etc. Exemplary embodiments of methods and systems develop professional networks and relationships based on career goals, develops connections between job description and skills with vendor solutions. Exemplary embodiments of methods and systems provide effective recruiting services and training services, as well as career management services. Users, including consultancy firms and enterprises are able to rank staff and identify critical personnel based on the standardized modeling, as well as identify staff for work flow reduction and/or re-organization based on the normalized data. Moreover, various embodiments of the method and system additionally reduce the time to identify resources internally or externally for recruitment, as well as reduce time to identify vendors or suppliers for projects based on needs analysis.

As described above, embodiments of the systems and methods provide for generalizing career data and then using this generalized career data to provide a rating and/or ranking of a user. This user rating and/or ranking is then usable for any number of benefits, including but not limited to employment eligibility to applying candidates to individuals deciding if they want or should apply. The user rating/ranking is usable for internal employee management. Moreover, based on the generation of a rating/ranking and the generalized career data, embodiments of the system generate a unified number assignable to the user's career. By analogy, individuals have credit scores that indicate their creditworthiness, the above-described technique generalized a corresponding professional score for the user. This score is usable for any number of assessment operations, as well as usable for user improvement, including recommendations for improving the user's rating/ranking by certification, education, networking, etc. As such, under embodiments of the present technique, user's career data is generalized and rated/ranked providing not only a general career rating/ranking value for the user, but corresponding knowledge for the user and the business environment based on this rating/ranking

Thus, as a further aspect of the present invention, a system is provided for managing occupation-related data, whereby a computing device can establish a job database for at least one job description, including a baseline categorization of success factors for the job description. This can occur, for example, when an HR professional wishes to evaluate candidates for a specific job or occupational position, for example. The baseline categorization can include one or more of the specific elements identified elsewhere herein, including education, experience, certifications, job training data, performance review data, etc. The computing device can further establish a rating database of individual career-related ratings, whereby the HR professional can access ratings and/or rankings for candidates, and further where the system can store ratings and/or rankings for corroborators to be used in the candidate ratings. Further, the user such as the HR professional can input, and/or the system can receive, configuration instructions associated with rating one or more individual candidates for employment associated with the job description, wherein the configuration instructions require input from at least one corroborator, and wherein the at least one corroborator has a career-related rating in the rating database. In this way, among other things, the HR professional can be assured that corroboration is tied to individuals that already have a rating in the system being employed. Further, the system can operate so as to, during or at a first time period, generate a rating for the one or more individual candidates based at least in part on input from the at least one corroborator. As such, a previously rated corroborator can provide input that affects the rating of the individual candidates to thereby give the HR professional greater certainty that the generated ratings are likely accurate and supportable by previously rated corroborators. In various embodiments of the present invention, the computing device is further operative to, during or at a second time period, generate an updated rating for the one or more individuals. The updated rating can be based on a change in the baseline categorization, a change in the input from the at least one corroborator, and/or a change in the career-related rating of the corroborator. In this way, the present invention can give recruiters, companies and various professionals dynamically and substantially continuously updated rating and/or ranking information associated with job candidates. Since some jobs are filled in the short term and others in the long term, the present invention provides evaluators with great flexibility in maintaining current rating and ranking information.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

1. A computerized method for managing career-related data, the method comprising:
establishing a database of a plurality of career types, with each of the plurality of career types having a baseline categorization of career success factors;
during or at a first time period,
receiving user career-related data comprising data associated with at least a portion of the career success factors for a first career type;
receiving user career veracity data associated with a corroborator;
determining a corroborator value factor;
based on the career veracity data and the corroborator value factor, determining a veracity factor;
based on the user career data and the veracity factor, generating a rating of the user career data;
during or at one or more additional time periods after the first time period,
updating one or more of the baseline categorization, the user career data and the user career veracity data; and
updating the rating.

2. The method of claim 1, including the further step of generating a user ranking based on the rating.

3. The method of claim 1, including the further step of electronically generating a gap analysis of the user career data based on general career data, wherein the gap analysis includes at least one determination of delta factors between the user career data and the general career data; and outputting at least one suggested career activity for the user based on the gap analysis.

4. The method of claim 1, wherein the baseline categorization includes a plurality of:
education level, job training data, performance review data, job experience data and professional recognition data.

5. A system for managing career-related data, comprising:
computer readable memory device having executable instructions stored therein; and
at least one processing device, in operative communication with the memory device for receiving executable instructions therefrom such that the processing device, in response to the executable instructions, is operative to:
establish a database of a plurality of career types, with each of the plurality of career types having a baseline categorization of career success factors;
during or at a first time period,
receive user career-related data comprising data associated with at least a portion of the career success factors for a first career type;
receive user career veracity data associated with a corroborator;
determine a corroborator value factor;
based on the career veracity data and the corroborator value factor, determine a veracity factor;
based on the user career data and the veracity factor, generate a ranking of the user career data;
during or at one or more additional time periods after the first time period,
update one or more of the baseline categorization, the user career data and the user career veracity data; and
update the ranking

6. The system of claim 5, wherein the at least one processing device is further operative to generate a user ranking based on the rating.

7. The system of claim 5, wherein the at least one processing device is further operative to generate a gap analysis of the user career data based on general career data, wherein the gap analysis includes at least one determination of delta factors between the user career data and the general career data; and outputting at least one suggested career activity for the user based on the gap analysis.

8. The system of claim 5, wherein the baseline categorization includes a plurality of:
education level, job training data, performance review data, job experience data and professional recognition data.

9. A system for managing occupation-related data, comprising:
computer readable memory device having executable instructions stored therein; and
at least one processing device, in operative communication with the memory device for receiving executable instructions therefrom such that the processing device, in response to the executable instructions, is operative to:
establish a job database for at least one job description, including a baseline categorization of success factors for the job description;
establish a rating database of individual career-related ratings;
receive configuration instructions associated with rating one or more individual candidates for employment associated with the job description, wherein the configuration instructions require input from at least one corroborator, wherein the at least one corroborator has a career-related rating in the rating database; and
during or at a first time period, generate a rating for the one or more individuals based at least in part on input from the at least one corroborator.

10. The system of claim 9, wherein the at least one processing device is further operative to, during or at a second time period subsequent to the first time period, generate an updated rating for the one or more individuals.

11. The system of claim 10 wherein the updated rating is based on a change in the baseline categorization.

12. The system of claim 10 wherein the updated rating is based on a change in the input from the at least one corroborator.

13. The system of claim 10 wherein the updated rating is based on a change in the career-related rating of the corroborator.

14. A computerized method for managing occupation-related data, the method comprising:
establishing a job database for at least one job description, including a baseline categorization of success factors for the job description;
establishing a rating database of individual career-related ratings;
receiving configuration instructions associated with rating one or more individual candidates for employment associated with the job description, wherein the configuration instructions require input from at least one corroborator, wherein the at least one corroborator has a career-related rating in the rating database; and
during or at a first time period, generating a rating for the one or more individuals based at least in part on input from the at least one corroborator.

15. The method of claim 14, further including the step of, during or at a second time period subsequent to the first time period, generate an updated rating for the one or more individuals.

16. The method of claim 15 wherein the updated rating is based on a change in the baseline categorization.

17. The method of claim 15 wherein the updated rating is based on a change in the input from the at least one corroborator.

18. The method of claim 15 wherein the updated rating is based on a change in the career-related rating of the corroborator.
